(19) United States
(12) Patent Application Publication
(10) Pub. No.: US 2024/0049696 A1
(43) Pub. Date: Feb. 15, 2024

(54) Chum Bobber

(71) Applicant: Chumbobber Unlimited LLC, Tomball, TX (US)

(72) Inventors: Stephen Dale Carter, Nicholasville, KY (US); Phillip Brent Carter, Tomball, TX (US); Kevin Clark Jones, Hideaway, TX (US)

(21) Appl. No.: 18/202,804

(22) Filed: May 26, 2023

Related U.S. Application Data
(60) Provisional application No. 63/368,881, filed on Aug. 12, 2022.

(51) Int. Cl. A01K 97/02; A01K 93/00

(52) U.S. Cl. CPC A01K 97/02; A01K 93/00

(57) ABSTRACT

A chum bobber with a first member comprising an integrated buoyancy chamber and a first coupling apparatus and a second member comprising a chum chamber and a second coupling apparatus for physically coupling to the first coupling apparatus. The first and second coupling apparatus are adapted for coupling the first member and the second member and thereby trapping chum into the second member while isolating the chum from the first member.

### RELATED APPLICATIONS

This application claims priority to U.S. patent application 63/368,881, Aug. 12, 2022, entitled “Chum Bobber,” which is hereby incorporated fully herein by reference.

### BACKGROUND

The example embodiments relate to chum fishing.

Chumming is a technique that attracts fish, typically in connection with fishing. Chumming, or to chum, is achieved by providing a volume of fish-attractive material (e.g., bait) into water to attract fish to a certain location. Chumming may be used in either fresh or salt water fishing. In a rudimentary manner, chum may be introduced into the water simply by throwing the chum into the water, for example from a boat or pier. In an alternative approach, devices may be used to hold a chum volume in the water, where portions of the chum separate from the volume and distribute into the water. Such devices may be as simple as bags, or may be more complicated devices such as bobbers that release chum and that also may connect to, or include, a fishing hook. One example of such a bobber is shown in U.S. Pat. No. 2,844,907, entitled “Fish Chum Dispenser” (the '907 patent). The '907 patent illustrates what appears to be a multi-part chum bobber including a body 10 with an upper part 11, a lower part 12, and a closure member 21. The closure member 21 threadably cooperates with the interior edge of the lower part 12 and thereby retains chum 13 in the lower part 12. The interior edge of the upper part 11 threadably cooperates with the outer edge of the closure remember 21, so that the closure member 21 is approximately intermediately positioned between the upper part 11 and the lower part 12. Additionally, a separate removal float 20 is retained in place by a holder 15, so that the removable float 20 is positionally affixed within the upper part 11. The body 10 includes perforations through both the upper part 11 and lower part 12, as does the intermediately-positioned closure member 21, so that the entire interior of the device is exposed to water and the particulates the water carries. Moreover, at least three-part, if not more so, assembly and disassembly is required in connection with positioning the chum 13 and removable float 20. Another example of a chum bobber is shown in U.S. Pat. No. 6,516,554, entitled “Combinational Bobber and Chum Dispenser” (the '554 patent). The '554 patent illustrates a chum dispenser 10 with one or more holes 30 at a distal end, with the holes 30 serving as both the entry and exit points for chum 25. While the '554 patent suggests a favorability of reduced expense and “requiring no complex moving parts,” it contradicts itself by describing and illustrating a rotatable closure member 34 for adjusting flow of its chum 25 and a wire 40 that is positioned axially through the device. A final example of a chum bobber is shown in U.S. patent application publication 2020/0068865, entitled “Retrievable Chum Dispenser” (the '865 publication). The '865 publication illustrates a chum dispenser 100, with at least three separable parts, namely: (1) an upper shell 110; (2) a lower shell 114; and (3) a removable buoyancy member 126 (shown with options 126A and 126B) that is “complementary in size and shape with the interior compartment of the lower shell 114 and . . . removably received therein.” The buoyancy member 126 includes a cavity 130 (130a or 130b) for receiving the chum 134. Accordingly, assembly of this chum dispenser 100 requires at least three separable parts, in addition to its chum, and the buoyancy member 126 consumes a portion of the lower shell 114, which also provides volume for the chum 134.

Examples are described below and that improve upon one or more aspects noted above.

### SUMMARY

In one embodiment, there is a chum bobber, comprising a first member comprising an integrated buoyancy chamber and a first coupling apparatus and a second member comprising a chum chamber and a second coupling apparatus for physically coupling to the first coupling apparatus. The first and second coupling apparatus are adapted for coupling the first member and the second member and thereby trapping chum into the second member while isolating the chum from the first member.

Other aspects are described and claimed.

### BRIEF DESCRIPTION OF THE DRAWINGS

FIG. 1 is an isometric view of a chum bobber 100.

FIG. 2 is a front perspective view of an upper member 102 of the FIG. 1 chum bobber 100.

FIG. 3 is a cross-sectional view of the FIG. 2 upper member 102.

FIG. 4 is a top view of the FIG. 2 upper member 102.

FIG. 5 is an isometric view of the FIG. 2 upper member 102.

FIG. 6 is a front perspective view of a lower member 104 of the FIG. 1 chum bobber 100.

FIG. 7 is a cross-sectional view of the FIG. 6 lower member 104.

FIG. 8 is a top view of the FIG. 6 lower member 104.

FIG. 9 is an isometric view of the FIG. 6 lower member 104.

FIG. 10 illustrates the chum bobber 100 in an exploded view.

FIG. 11 illustrates a cross section of the chum bobber 100 in an assembled view.

FIG. 12 illustrates an environmental example 150 of the chum bobber 100.

### DETAILED DESCRIPTION

The following description, in conjunction with the appended drawings, describe one or more representative example embodiments. Unless otherwise indicated, they are intended to be non-limiting examples for illustrating the principles and concepts of claimed subject matter. Like numbers refer to like elements in the drawings and the description.

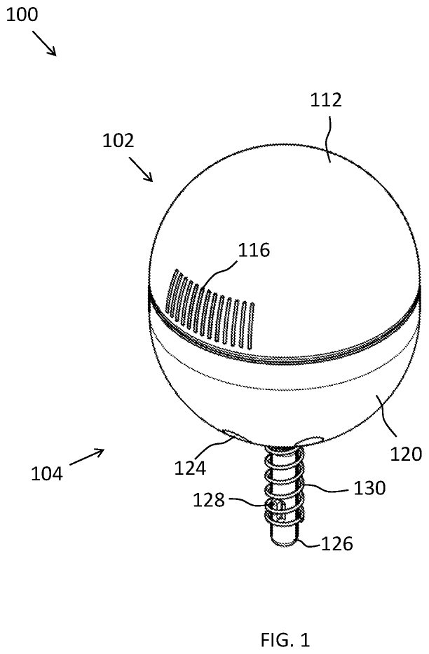

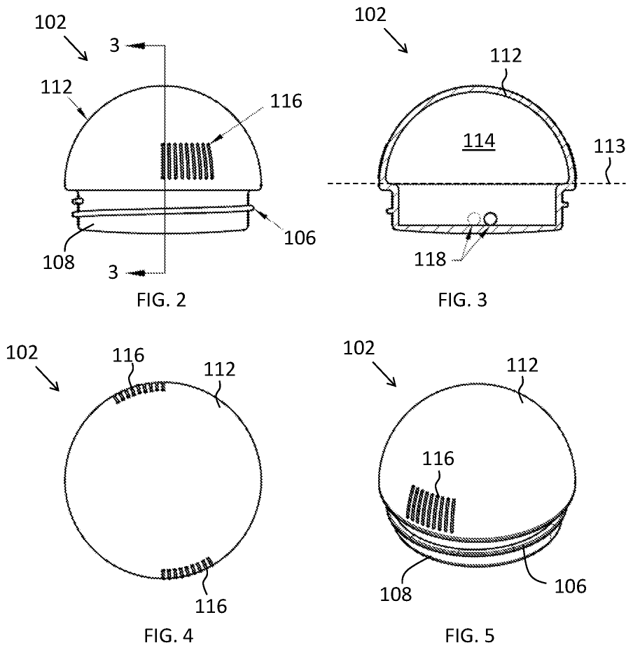

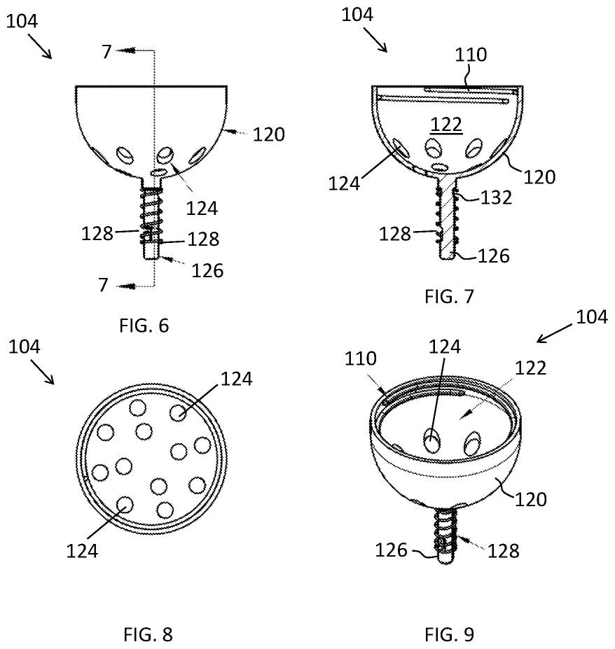

FIG. 1 is an isometric view of a chum bobber 100. Generally, the chum bobber 100 includes an upper member 102 and a lower member 104. Each of the upper member 102 and the lower member 104, in an example, is generally hemispherical in outer shape (or includes a hemispherical portion), with an outer diameter in a range from 25 mm to 100 mm. The upper member 102 is shown in additional detail in later figures, including a front perspective view in FIG. 2, a cross-sectional view in FIG. 3, a top perspective view in FIG. 4, and an isometric view in FIG. 5. The lower member 104 is shown in additional detail in later figures, including a front perspective view in FIG. 6, a cross-sectional view in FIG. 7, a top perspective view in FIG. 8, and an isometric view in FIG. 9. The upper and lower members 102 and 104 include a cooperating apparatus so as to affix the two members relative to one another. For example, one or the other of the upper member 102 and the lower member 104 includes a set of male protruding threads, while the other includes a set of female receptacle threads. In the FIGS. 2, 3, and 5 example, the male protruding threads are shown as male threads 106 extending from a flange 108 that protrudes away from an equator 113 of the upper member 102, and in the FIGS. 7, 8, and 9 example, the female receptacle threads are shown as female threads 110 within an interior of the lower member 104. Accordingly, one or the other, or both of, the upper and lower members 102 and 04 may be rotated in opposite directions while the threads 106 and 110 are mated to one another, thereby affixing the members together in a threadable relationship. Conversely, the upper and lower members 102 and 104 may be de-coupled from one another by unscrewing in the opposite direction, for example when needing access to an interior of the lower member 104, as further described below.

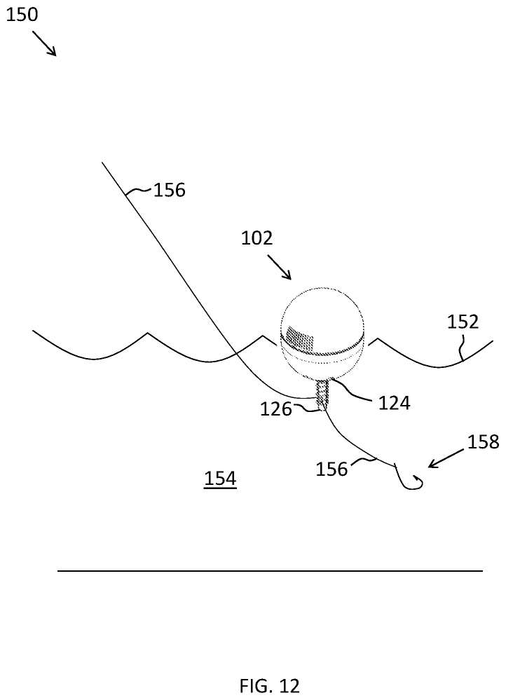

Details are now described regarding the upper member 102, as shown in FIGS. 2-5. In an example, the upper member 102 has an exterior wall 112, within which is located a sealed hollow interior space 114. The exterior wall 112 may have a thickness in a range from 1 mm to 2.25 mm. Further, the entirety of the exterior wall 112 may be formed of a same material, such as plastic, for example using a blow molding process, and to fully enclose the sealed hollow interior space 114. Accordingly, when the chum bobber 100 is eventually placed in water (see, for example, FIG. 12), no water can enter into the upper member 102 (or its airtight, sealed hollow interior space 114). Instead, a gas, such as ambient air, is trapped in the sealed hollow interior space 114. Accordingly, the sealed hollow interior space 114 serves as an integrated (inseparable) buoyancy chamber into the upper member 102, thereby giving the upper member 102 buoyancy, and that buoyancy also will support the lower member 104 filled with chum when it is coupled (e.g., screwed together with) to the upper member 102. An outer surface of the exterior wall 112 includes at least one gripping member 116. In an example, the gripping member 116 may include one or more ridges, for example generally parallel to one another, formed within this surface, but not extending through, the exterior wall 112. Also as shown in FIG. 4, the exterior wall 112 may include multiple gripping members 116. Accordingly, when a user assembles the upper and lower members 102 and 104 to one another, such assembly may be facilitated by the user gripping the upper member 102 by contacting his or her hands to the gripping member(s) 116. Lastly, the upper member 102 may include a noise-creating apparatus 118. In the illustrated example, the noise-creating apparatus 118 is accomplished by including one or more loose members, for example metal spheres, within the sealed hollow interior area 114. The metal spheres can be inserted through the blow mold hole after the blow molding process used to form the exterior wall 112 is completed. The blow mold hole would then be subsequently sealed. The metal spheres may have a diameter in a range from 2 mm to 4 mm. Accordingly, as the chum bobber 100 is advanced within water, the metal spheres 118 may move fully with the entire interior area 114 and thereby create noise, for example so as to attract fish. Notably, the noise-creating apparatus 118 is isolated from contact with water that will surround the chum bobber 100, when it is used for fishing (and that can enter the lower member 104). As a result, the noise-creating apparatus 118 is protected from potential dirt, grease, grime, or other particulates or materials that could prematurely age, weaken, or render inoperable the noise-creating function of the noise-creating apparatus 118.

Details are now described regarding the lower member 104, as shown in FIGS. 6-9. In an example, the lower member 104 has an exterior wall 120, and the interior of the exterior wall 120 provides a hollow interior space 122. The exterior wall 120, like the exterior wall 112 of the upper member 102, may have a thickness in a range from 1 mm to 2.25 mm. The hollow interior space 122 is not fully enclosed, as compared to the sealed hollow interior space 114 of the upper member 102. Instead, when the upper and lower members 102 and 104 are separated from one another, the hollow interior space 122 is readily accessible from outside the lower member 104, so for example a user may place chum (not shown) into the hollow interior space 122, without the need unlike some prior art bobbers to add additional elements into an interior space so as to position or otherwise accommodate the chum, and where such additional elements consume part of the inner volume of the chum bobber and thereby prevent the use of such volume to hold yet more chum. Further, once the user adds chum into the hollow interior space 122, the user assembles the upper and lower members 102 and 104 together. Further, for example, because the hollow interior space 122 is not fully enclosed when the upper and lower members 102 and 104 are separated from each other, the entirety of the lower member 104 may be formed using an injection molding process. An outer surface of the exterior wall 120 includes at least one, and preferably multiple, holes 124 extending through the exterior wall 120. Each hole 124 may have a diameter (or major axis, if not circular) in a range from 3.25 mm to 7.5 mm. Accordingly, when chum is inserted into the hollow interior space 122, and when the chum bobber 100 is there after deposited in water, the chum may dissipate through the multiple holes 124 into the water, for example due to gravity and or the movement of the chum bobber 100 within the water. Notably, no additional and movable apparatus is included or necessary to cause the chum to dissipate in this manner, and that otherwise would complicate and increase the complexity and expense, and possibly reduce the lifespan or utility, of the chum bobber 100. The lower member 104 also includes a stem 126, extending away from the exterior wall 120. In an example, the stem 126 has a generally solid cylindrical shape, with an overall length in a range from 17 mm to 38.25 mm and a main diameter in a range from 3 mm to 7 mm. The stem 126 may be monolithically formed as part of the lower member 104, for example in the same molding (e.g., injection molding) process, and from a same material (e.g., plastic), that forms the exterior wall 120. The stem 126 also includes a notch 128, for example near the distal tip of the stem 126. The notch 128 includes a radial portion inward from the outer circumference of the stem 126 (the radial portion can be perpendicular or at an angle other than 90 degrees relative to the stem 126), and an axial portion further inward from the inward end of the radial portion. A spring 130 is axially positioned around the stem 126, and has an axial length just shorter than the stem 126. The stem 126 has a smaller diameter section located on the upper end so that a groove 132 is created in the stem 126. The spring 130 has a smaller diameter at the upper end (smaller than the stem 126 main diameter but larger than the groove 132) so that the upper end of the spring 130 positions inside of the groove 132 and is permanently affixed to the stem 126. In operation, a user may compress the spring 130, for example in the upward direction shown in FIGS. 6, 7, and 9, so as to expose the notch 128. Once the notch 128 is so exposed, the user may place a fishing line (shown later in FIG. 12) through the notch 128, and then release the spring 130, so that the released spring retains and traps the fishing line within the notch 128. Accordingly, the chum bobber 100 may be positioned in water and by pulling on the fishing line, the pulling force is translated, via the notch 128, to advance the chum bobber 100 in the water. Further, the line also may be positioned within the notch 128 so that a hook (shown later in FIG. 12) on the line can be positioned nearby the chum bobber 100. Still further, note that the combination of the stem 126 (with its notch 128) and the spring 130 allows affixation to a fishing line away from the interior of the chum bobber 100, and thereby does not introduce any additional complexity or potential wear to that interior. Additionally, unlike certain bobbers that use a fixed metal as the sole manner of retaining a fishing line, and in some cases where the metal penetrates the bobber providing points of particulate accumulation and/or eventual wear or damage, the example illustrated has a portion of the retention by the stem 126. The stem 126 does not interfere with the interior of the bobber, and from this, and also potentially by its material (e.g., plastic) will be less vulnerable to potential rust and snagging, and less intrusive to the remainder of the bobber. Further, to the extent the spring 130 becomes worn, it is more readily replaced as a removable portion of the entire unit, as compared to approaches that include an eyelet or other intricately-bent metal that is permanently affixed to the bobber.

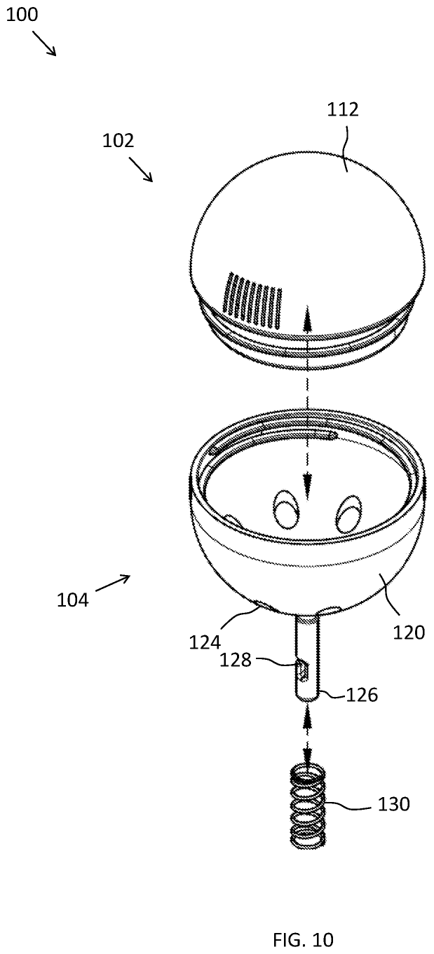

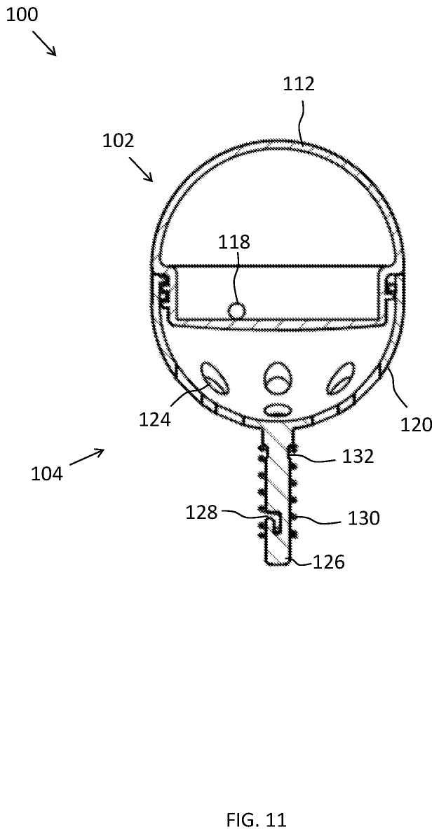

FIG. 10 illustrates the chum bobber 100 in an exploded view, and FIG. 11 illustrates a cross section of the chum bobber 100 in an assembled view. FIG. 12 illustrates an environmental example 150 of the chum bobber 100 along a surface 152 of water 154, with the stem 126 extending into the water 154. A fishing line 156 is attached to the chum bobber 100 as described earlier. A hook 158 also may be attached to an end of the fishing line 156, and the hook 158 may include additional bait (not shown). Accordingly, in the environmental example 150, it is assumed that the chum bobber 100 was earlier loaded with chum, so as it rests in the water 154, or is pulled along the water surface 152 by pulling on the fishing line 156, chum may disperse through the holes 124 and attract fish to the area of the hook 158.

Given the preceding, the chum bobber 100 may be used in connection with fishing. The chum bobber 100 is both a functioning bobber that floats and holds chum, which may include shrimp, dog food, or any bait a user wants to use to attract fish to their hook. The chum bobber 100 may be disassembled, so as to load chum in it, by unscrewing only two parts relating to chum (i.e., the upper and lower members 102 and 104), loading in the chum, then re-assembling (e.g., screwing) back together the two parts, completing an assembly with no moving parts in connection with distribution of the chum. Thereafter, when the chum bobber 100 is placed in water, the chum will leak into the water through the holes 124, thus attracting fish by the smell/chunks of chum in the water. The foregoing description is of exemplary and example embodiments. Further, alterations and modifications to the disclosed embodiments may be made without departing from the inventive scope. For example, while certain dimensions, or ranges of dimensions have been provided, various aspects may be applied to other sizes that can be used for fishing purposes. Accordingly, the inventive scope, as defined by the appended claims, is not limited to the described embodiments.

What is claimed is:

1. A chum bobber, comprising:
a first member comprising an integrated buoyancy chamber and a first coupling apparatus; and
a second member comprising a chum chamber and a second coupling apparatus for physically coupling to the first coupling apparatus; and
wherein the first and second coupling apparatus are adapted for coupling the first member and the second member and thereby trapping chum into the second member while isolating the chum from the first member.

2. The chum bobber of claim 1 wherein one of the first and second coupling apparatus comprises male threads and another of the first and second coupling apparatus comprises female threads.

3. The chum bobber of claim 1 wherein each of the first member and the second member comprises a hemispherical member.

4. The chum bobber of claim 1 wherein at least one of the first member and the second member comprises a gripping member formed into a surface of the at least one of the first member and the second member.

5. The chum bobber of claim 1 wherein the first member comprises an airtight member.

6. The chum bobber of claim 1 wherein the first member comprises a noise-generating apparatus.

7. The chum bobber of claim 6 wherein the noise-generating apparatus is within a chamber isolated from water.

8. The chum bobber of claim 6 wherein the noise-generating apparatus comprises one or more loose members.

9. The chum bobber of claim 6 wherein the noise-generating apparatus comprises one or more spheres.

10. The chum bobber of claim 1 wherein the second member comprises an outer surface that includes multiple holes.

11. The chum bobber of claim 10, wherein the second member has an opening, proximate the second coupling apparatus, for receiving the chum, and the opening has a larger diameter than a diameter of each of the multiple holes.

12. The chum bobber of claim 1 wherein the second member comprises a stem protruding away from a curved surface, the stem comprising a notch for receiving a fishing line.

13. The chum bobber of claim 12 and further comprising a spring axially positioned around the stem.

14. The chum bobber of claim 1 wherein the second member comprises a line attaching mechanism protruding away from a surface of the second member.

15. The chum bobber of claim 1 wherein the integrated buoyancy chamber is bordered by an outer wall of the first member.

16. A method of chumming, comprising:
locating chum in a chum chamber of a second member of a chum bobber; and
coupling a first member of a chum bobber to a second member of the chum bobber, the first member comprising an integrated buoyancy chamber and a first coupling apparatus and the second member comprising the chum chamber and a second coupling apparatus for physically coupling to the first coupling apparatus.

17. The method of claim 16 and further comprising locating the chum bobber in a body of water, wherein chum is dispensed from the chum bobber through multiple holes into the body of water while water cannot enter the first member.

18. The method of claim 16 and further comprising attaching a fishing line to the chum bobber by:
first, compressing a spring to provide access to a notch in the chum bobber;
second, locating the fishing line in the notch; and
third, releasing compression in the spring.

19. The method of claim 16 wherein the integrated buoyancy chamber is bordered by an outer wall of the first member.
